(19) United States
(12) Patent Application Publication
(10) Pub. No.: US 2013/0054205 A1
(43) Pub. Date: Feb. 28, 2013

(54) MODEL TRANSFORMING DEVICE, MODEL TRANSFORMING METHOD, AND PROGRAM

(71) Applicant: Hiroyuki Yagi, Kanagawa (JP)

(72) Inventor: Hiroyuki Yagi, Kanagawa (JP)

(73) Assignee: Sony Corporation, Tokyo (JP)

(21) Appl. No.: 13/590,823

(22) Filed: Aug. 21, 2012

(30) Foreign Application Priority Data
Aug. 25, 2011 (JP) 2011-183827

(51) Int. Cl. G06F 7/60

(52) U.S. Cl. 703/2

(57) ABSTRACT

A model transforming device includes: a processing section configured to modify respective algebra expressions of an interface model for simulation in a fixed description style and an interface model for behavioral synthesis in a fixed description style, and when both of the algebra expressions after being modified match each other, determine that the models have equivalence, and perform mutual transformation of the models. The processing section performs mutual equivalent transformation of hierarchical channel and integration channel model transformation by following three operations a, b, and c maintaining algebraic equivalence: a: mutual equivalent transformation by payload disclosure and payload concealment operation, b: interface and channel decomposition and interface and channel integration, and c: process remapping operation.

### BACKGROUND

The present technology relates to a model transforming device, a model transforming method, and a program for mutually transforming a so-called interface model for simulation and an interface model for behavioral synthesis.

An interface model for simulation described in SystemC and an interface model for behavioral synthesis are different from each other in description style and abstraction level.

The interface model for simulation connects ports of modules to each other by a channel.

The model for behavioral synthesis connects pin terminals of modules to each other by wire (sc_signal channel) in terms of hardware.

In general, following two methods are adopted as methods for transformation from such an interface model for simulation to such an interface model for behavioral synthesis.

The first method is a method of rewriting models manually.

Incidentally, for the first method, reference is to be made to the description of SystemC Synthesizable Subset Draft 1.3 (downloadable from http://www.systemc.org/downloads/drafts_review), hereinafter as Non-Patent Document 1. FIG. 1.5 on page 15 in Non-Patent Document 1 shows manual refinement between a SysC/C++/C module and a Synthesizable SysC/C++/C model.

This is none other than the manual rewriting of a model. Incidentally, SysC is an abbreviation of SystemC in Non-Patent Document 1.

The second method constructs a model and forms the model into a library in advance in two description styles, and checks for expectation matching by simulation under input conditions given each time the library is used.

The second method is a derivation of the first method in an aspect of operation, which derivation would be easily made by those skilled in the art.

In addition, the formalization of UML (Unified Modeling Language) class diagrams is described in detail in Berardi, Calvanese, De Giacomo, “Reasoning on UML class diagrams,” Artificial Intelligence Vol. 168, Issue 1, hereinafter as Non-Patent Document 2.

Semantic consistency judgment between UML class diagrams is described in Hidekazu Enjo, Motonari Tanabu, and Junichi Iijima, “A consideration to class diagram algebra in semantic consistency judgment between class diagrams,” Proceedings of the National Conference of the Japan Society for Management Information 2008 Spring and the National Conference of the Japan Society for Management Information 2008 Autumn, pp. E3-3, November 2008; Hidekazu Enjo and Junichi Iijima, “A consideration to class diagram algebra in consistency judgment between class diagrams,” Proceedings of the National Conference of the Japan Society for Management Information 2008 Spring and the National Conference of the Japan Society for Management Information 2008 Spring, pp. H4-2, June 2008; and Hidekazu Enjo and Junichi Iijima, “A consideration to class diagram algebra in consistency judgment between class diagrams,” Proceedings of the National Conference of the Japan Society for Management Information 2008 Spring and the National Conference of the Japan Society for Management Information 2008 Spring, pp. H4-2, June 2008, hereinafter as Non-Patent Document 3, Non-Patent Document 4, and Non-Patent Document 5, respectively.

### SUMMARY

However, according to the first method, double maintenance for the two models of the interface model described in SystemC and the interface model capable of behavioral synthesis needs to be kept at each time of design.

Alternatively, according to the first method, there is no choice but to use the interface model capable of behavioral synthesis as a reference model in a logic synthesis phase as a next design phase and subsequent phases, and give up the maintenance of the interface model described in SystemC.

When the library formation method as the second method is used, the accuracy of expectation matching by simulation under given input conditions of the two models used as the library can be increased by sufficiently accumulating actual results.

However, because the second method makes judgment by only actual result values, it is necessary to check whether the input conditions fall under the category of input conditions with actual results at each time of design, or to perform expectation matching verification by simulation again.

If a problem should occur, it is necessary to reconsider validity under the input conditions of the interface library used, or to suspect an error in user description at a position where the interface library is used, and an enormous amount of debug time is required.

As described above, the formalization of UML class diagrams is described in detail in Non-Patent Document 2.

However, this description is aimed at the mathematical semantics of classes only, and does not at all refer to, or does not suggest either, the formalization of UML component diagrams including instances of classes and connection structure between the instances.

In addition, as described above, semantic consistency judgment between UML class diagrams is described in Non-Patent Documents 3 to 5.

However, Non-Patent Documents 3 to 5 do not at all refer to, or do not suggest either, consistency judgment between UML component diagrams including instances of classes and connection structure between the instances as described above.

Further, Non-Patent Documents 3 to 5 do not disclose a procedure for model transformation by operation based on mathematical consistency, but only simply judge consistency after arbitrary operation.

It is desirable to provide a model transforming device, a model transforming method, and a program capable of mutually transforming an interface model for simulation and an interface model for behavioral synthesis while maintaining equivalence without taking complex labor and time.

According to a first embodiment of the present technology, there is provided a model transforming device. The device includes: a processing section configured to modify respective algebra expressions of an interface model for simulation in a fixed description style and an interface model for behavioral synthesis in a fixed description style, and when both of the algebra expressions after being modified match each other, determine that the models have equivalence, and perform mutual transformation of the models. A hierarchical channel is used for interface description, the hierarchical channel being a channel class capable of internally having processes and being formed of a data class referred to as a payload in which data itself as an object of transfer and a signal necessary for communication to transfer the data are integrated. The processing section performs mutual equivalent transformation of hierarchical channel and integration channel model transformation by following three operations a, b, and c maintaining algebraic equivalence: a: mutual equivalent transformation by payload disclosure and payload concealment operation, b: interface and channel decomposition and interface and channel integration, and c: process remapping operation.

According to a second embodiment of the present technology, there is provided a model transforming method. The method includes: modifying respective algebra expressions of an interface model for simulation in a fixed description style and an interface model for behavioral synthesis in a fixed description style; determining whether both of the algebra expressions after being modified match each other; and when both of the algebra expressions after being modified match each other, determining that the models have equivalence, and performing mutual transformation of the models. A hierarchical channel is used for interface description, the hierarchical channel being a channel class capable of internally having processes and being formed of a data class referred to as a payload in which data itself as an object of transfer and a signal necessary for communication to transfer the data are integrated. Mutual equivalent transformation of hierarchical channel and integration channel model transformation is performed by following three operations a, b, and c maintaining algebraic equivalence: a: mutual equivalent transformation by payload disclosure and payload concealment operation, b: interface and channel decomposition and interface and channel integration, and c: process remapping operation.

According to a third embodiment of the present technology, there is provided a program for making a computer perform model transformation processing. The program includes: modifying respective algebra expressions of an interface model for simulation in a fixed description style and an interface model for behavioral synthesis in a fixed description style; determining whether both of the algebra expressions after being modified match each other; and when both of the algebra expressions after being modified match each other, determining that the models have (mathematical) equivalence, and performing mutual transformation of the models. A hierarchical channel is used for interface description, the hierarchical channel being a channel class capable of internally having processes and being formed of a data class referred to as a payload in which data itself as an object of transfer and a signal necessary for communication to transfer the data are integrated. Mutual equivalent transformation of hierarchical channel and integration channel model transformation is performed by following three operations a, b, and c maintaining algebraic equivalence: a: mutual equivalent transformation by payload disclosure and payload concealment operation, b: interface and channel decomposition and interface and channel integration, and c: process remapping operation.

According to the present technology, it is possible to mutually transform an interface model for simulation and an interface model for behavioral synthesis while maintaining equivalence without taking complex labor and time.

### BRIEF DESCRIPTION OF THE DRAWINGS

FIG. 1 is a diagram showing an example of configuration of a model transforming device according to a present first embodiment;

FIGS. 2A, 2B, and 2C are flowcharts of an outline of arithmetic processing of a model transforming program according to the present embodiment;

FIGS. 3A, 3B, and 3C are flowcharts of an outline of concrete model transformation processing in the arithmetic processing of the model transforming program according to the present embodiment;

FIG. 4 is a diagram showing an example of configuration of a model transforming device according to a present second embodiment;

FIG. 5 is a diagram showing an example of configuration of a model transforming device according to a present third embodiment;

FIG. 6 is a diagram showing an example of configuration of a model transforming device according to a present fourth embodiment;

FIG. 7 is a UML component diagram of an interface model system described in SystemC;

FIG. 8 is a class diagram of a hierarchical channel;

FIG. 9 is a UML component diagram of an interface model system capable of behavioral synthesis after model transformation;

FIG. 10 is a class diagram of an interface part after the model transformation;

FIGS. 11A, 11B, and 11C are diagrams of assistance in explaining a first example;

FIG. 12 is a diagram of assistance in explaining a second example; and

FIG. 13 is a diagram showing a case of design in which channel decomposition is performed on only a hardware side.

### DETAILED DESCRIPTION OF THE PREFERRED EMBODIMENTS

Preferred embodiments of the present technology will be described with reference to the drawings.

Incidentally, description will be made in the following order.

### 1. First Embodiment (First Example of Configuration of Model Transforming Device)

### 2. Second Embodiment (Second Example of Configuration of Model Transforming Device)

### 3. Third Embodiment (Third Example of Configuration of Model Transforming Device)

### 4. Fourth Embodiment (Fourth Example of Configuration of Model Transforming Device)

### 5. More Concrete Processing Example of Model Transformation Processing

### 6. First Example

### 7. Second Example

### 8. Third Example

### 9. Fourth Example

### 10. Fifth Example

### 1. First Embodiment

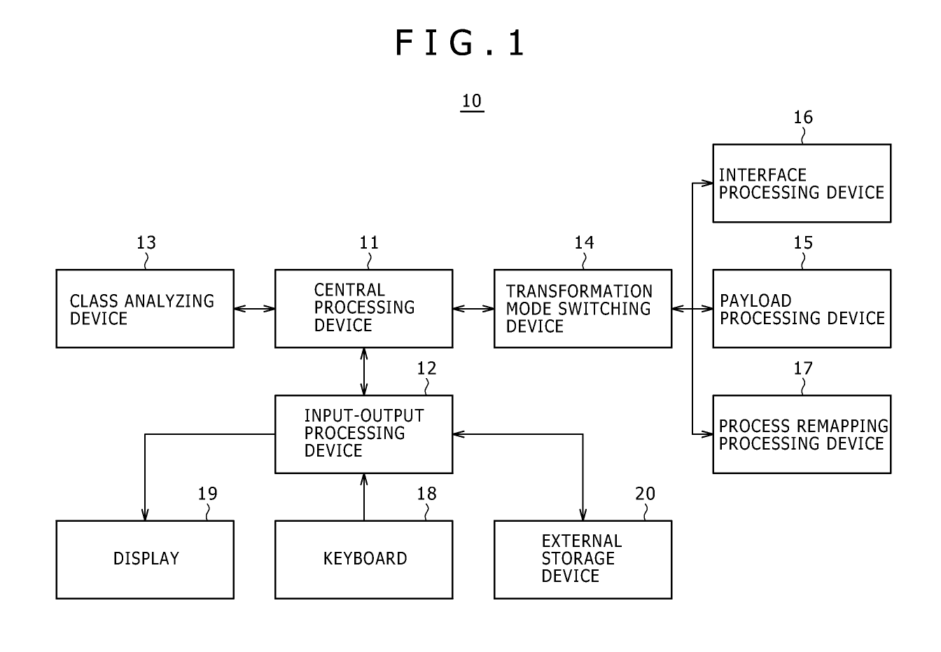

FIG. 1 is a diagram showing an example of configuration of a model transforming device according to a present first embodiment.

The model transforming device 10 of FIG. 1 includes a central processing device 11, an input-output processing device 12, a class analyzing device 13, a transformation mode switching device 14, a payload processing device 15, an interface processing device 16, and a process remapping processing device 17.

The model transforming device 10 includes a keyboard 18, a display 19 such as an LCD or the like, and an external storage device 20, whose input and output of information is controlled by the input-output processing device 12.

The model transforming device 10 is applied to a first example to be described later.

The central processing device 11, the input-output processing device 12, the class analyzing device 13, the transformation mode switching device 14, the payload processing device 15, the interface processing device 16, and the process remapping processing device 17 form a processing section.

Incidentally, the respective processing of the class analyzing device 13, the transformation mode switching device 14, the payload processing device 15, the interface processing device 16, and the process remapping processing device 17 can be performed by a program.

A hierarchical channel, which is a channel class capable of internally having processes and is formed of a data class referred to as a payload in which data itself as an object of transfer and a signal necessary for communication to transfer the data are integrated, is used for interface description.

The processing section according to the present embodiment modifies the respective algebra expressions of an interface model for simulation in a fixed description style and an interface model for behavioral synthesis in a fixed description style.

When both of the algebra expressions after being modified match each other, the processing section determines that the models have mathematical equivalence, and performs mutual transformation of the models.

The processing section then performs mutual equivalent transformation of hierarchical channel and integration channel model transformation by following three operations a, b, and c maintaining algebraic equivalence:

a: mutual equivalent transformation by payload disclosure and payload concealment operation,

b: interface and channel decomposition and interface and channel integration, and

c: process remapping operation.

In a transformation mode for transforming the interface model for simulation into the interface model for behavioral synthesis (hierarchical channel search), the processing section performs payload disclosure undoing a bundle of a channel, interface and channel decomposition, and process remapping.

The transformation mode for transforming the interface model for simulation into the interface model for behavioral synthesis (hierarchical channel search) will be set as a first transformation mode.

In a transformation mode for transforming the interface model for behavioral synthesis into the interface model for simulation (integration channel search), the processing section performs payload concealment binding channels, interface and channel integration, and process remapping.

The transformation mode for transforming the interface model for behavioral synthesis into the interface model for simulation (integration channel search) will be set as a second transformation mode. In the present embodiment, following four algebraic definitions of semantics e, f, g, and h are given as the algebra definitions described above:

e: class equivalence meaning that classes are interchangeable,

f: conditional class equivalence meaning that classes are interchangeable conditionally,

g: derived class meaning that a class is derived from a certain class, and

h: member function meaning that a certain function belongs to a certain class.

In the present embodiment, when a SystemC language is a design description language, following seven algebraic definitions of semantics i, j, k, l, m, n, and o are given as the algebra definitions described above:

i: an sc_channel and an sc_module are class-equivalent to each other,

j: all interface classes are a derived class of an sc_interface class,

k: all port classes are a derived class of an sc_port class with an interface class as a template parameter,

l: a port class binds a channel class,

m: a condition of M,

n: when a certain port class binds a certain channel class, and there is a certain unique function,
n1: the member function of the port class when the certain port class is a derived class of a certain interface class and
n2: the member function of the channel class when the port class is a derived class of an sc_port with the certain interface class as a template parameter and the certain channel is a derived class of the certain interface class are equivalent to each other, and

o: a condition for a certain port class to bind a certain channel class is equivalent to a condition for all primitive ports belonging to the port class to bind all primitive channels belonging to the channel.

In such a processing section, the central processing device 11 controls the whole of the model transforming device 10 in an integrated manner.

The central processing device 11 is supplied via the input-output processing device 12 with information on an interface model for simulation in a fixed description style and an interface model for behavioral synthesis in a fixed description style, the information being input from the keyboard 18 or the external storage device 20.

The central processing device 11 supplies the model information input from the input-output processing device 12 to the class analyzing device 13.

The central processing device 11 makes the payload processing device 15, the interface processing device 16, and the process remapping processing device 17 perform processing corresponding to switching information of the transformation mode switching device 14.

The class analyzing device 13 performs class analysis processing on the basis of structural information obtained from the input model information, and creates a database. Information on the database is passed through the input-output processing device 12, and displayed on the display 19 and stored in the external storage device 20.

The transformation mode switching device 14 notifies the central processing device 11, the payload processing device 15, the interface processing device 16, and the process remapping processing device 17 to perform processing corresponding to the first transformation mode or the second transformation mode.

The payload processing device 15 performs payload disclosure processing that undoes a bundle of a channel in the first transformation mode.

The payload processing device 15 performs payload concealment processing that bundles channels in the second transformation mode.

The interface processing device 16 performs interface and channel decomposition (API decomposition) processing in the first transformation mode.

The interface processing device 16 performs interface and channel integration (API integration) processing in the second transformation mode.

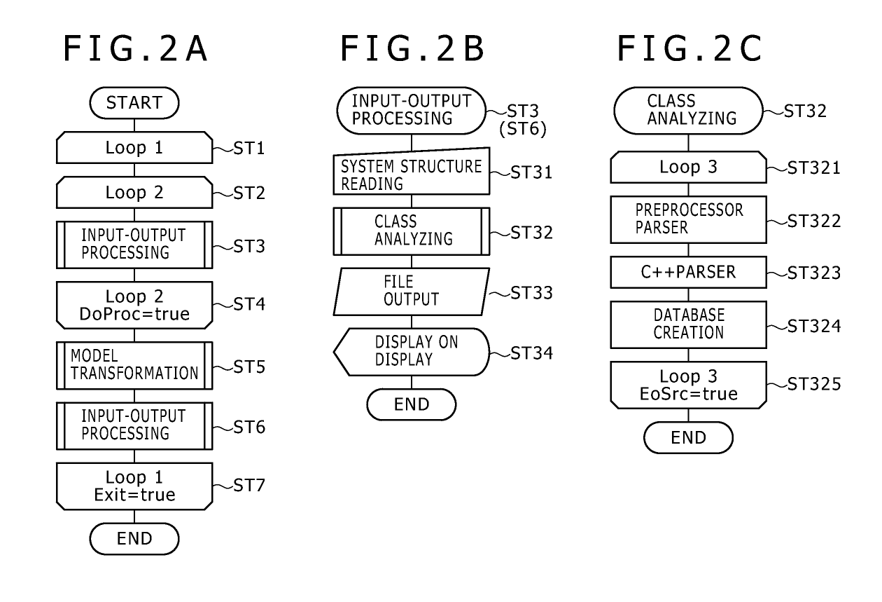

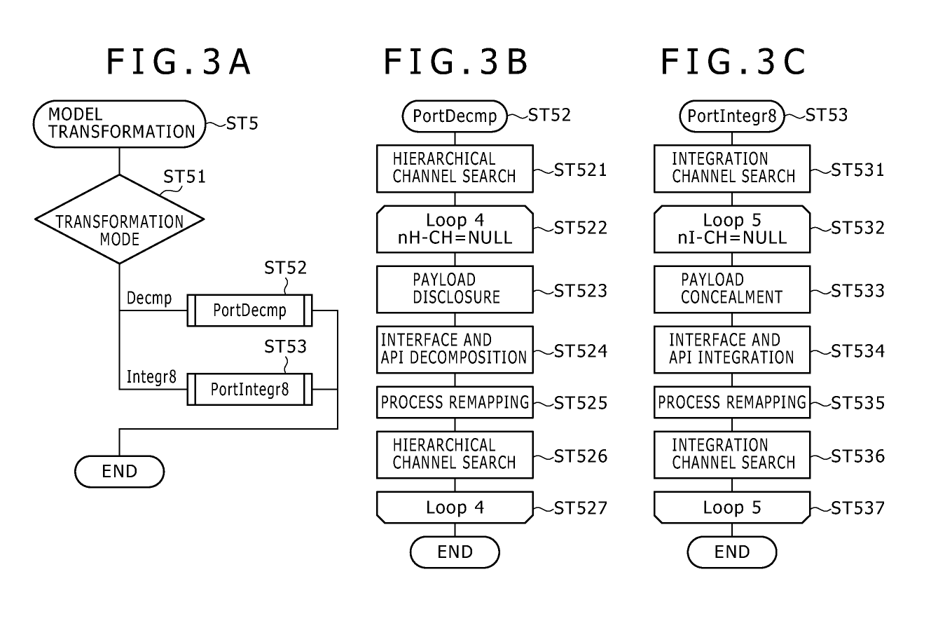

The process remapping processing device 17 performs process remapping processing corresponding to the first transformation mode or the second transformation mode. FIGS. 2A to 2C and FIGS. 3A to 3C are flowcharts of the arithmetic processing of a model transforming program according to the present embodiment.

FIG. 2A shows an outline of processing of the whole of the model transforming program. FIG. 2B shows input-output processing. FIG. 2C shows class analysis processing.

FIG. 3A shows an outline of concrete model transformation processing. FIG. 3B shows processing in the first transformation mode. FIG. 3C shows processing in the second transformation mode.

The model transforming program according to the present embodiment as a whole is executed including the process of steps ST1 to ST7 shown in FIG. 2A.

Of steps ST1 to ST7, the input-output processing of step ST3, the model transformation processing of step ST5, and the input-output processing of step ST6 are performed as main processing.

The input-output processing of steps ST3 and ST6 is performed as shown in FIG. 2B.

In step ST31, the central processing device 11 reads the structure of a system from information on an interface model for simulation and an interface model for behavioral synthesis, the information being input via the input-output processing device 12.

Next, in step S32, the class analyzing device 13 performs class analysis.

In step ST33, a file is output via the input-output processing device 12.

Then, in step S34, the file is displayed on the display 19.

The class analysis processing of step ST32 is performed including the process of steps ST321 to ST325 shown in FIG. 2C.

Of steps ST321 to ST325, the preprocessor parser of step ST322, the C++ parser of step ST323, and the database creation processing of step ST324 are performed as main processing.

Specifically, the model transformation processing of step ST5 is performed including the processing shown in FIG. 3A to 3C.

This model transformation processing is performed mainly by the central processing device 11, the transformation mode switching device 14, the payload processing device 15, the interface processing device 16, and the process remapping processing device 17.

First, as a whole, as shown in FIG. 3A, whether a transformation mode is the first transformation mode or the second transformation mode is determined in step S51.

When the transformation mode is the first transformation mode, the process of step ST52 is performed. When the transformation mode is the second transformation mode, the process of step ST53 is performed.

The process in the first transformation mode of step ST52 is performed including the process of steps ST521 to ST527 shown in FIG. 3B.

In step ST521 among steps ST521 to ST527, a hierarchical channel search is started.

Then, the payload disclosure processing of step ST523, the interface and channel decomposition (API decomposition) processing of step ST524, and the process remapping processing of step ST525 are performed as main processing.

The process in the second transformation mode of step ST53 is performed including the process of steps ST531 to ST537 shown in FIG. 3C.

In step ST531 among steps ST531 to ST537, an integration channel search is started.

Then, the payload concealment processing of step ST533, the interface and channel integration (API integration) processing of step ST534, and the process remapping processing of step ST535 are performed as main processing.

### 2. Second Embodiment

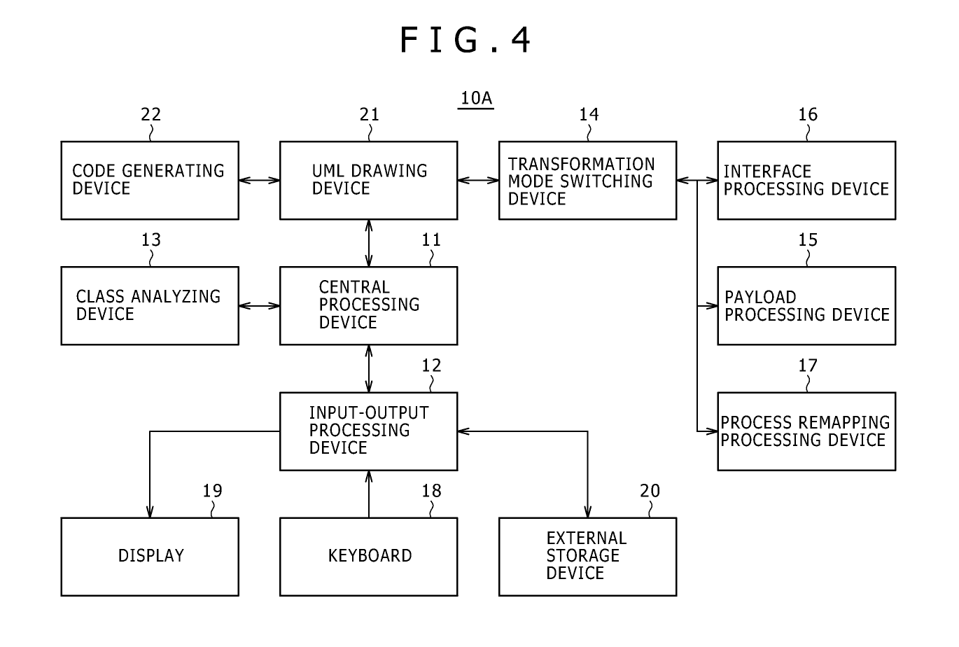

FIG. 4 is a diagram showing an example of configuration of a model transforming device according to a present second embodiment.

The model transforming device 10A of FIG. 4 is different from the model transforming device 10 of FIG. 1 in that the model transforming device 10A has a UML drawing device 21 and a code generating device 22.

A central processing device 11 communicates with a transformation mode switching device 14 via the UML drawing device 21.

The other configuration is similar to that of the model transforming device 10 of FIG. 1.

Incidentally, the respective processing of the UML drawing device 21 and the code generating device 22 can be performed by a program.

The model transforming device 10A is applied to a second example to be described later.

### 3. Third Embodiment

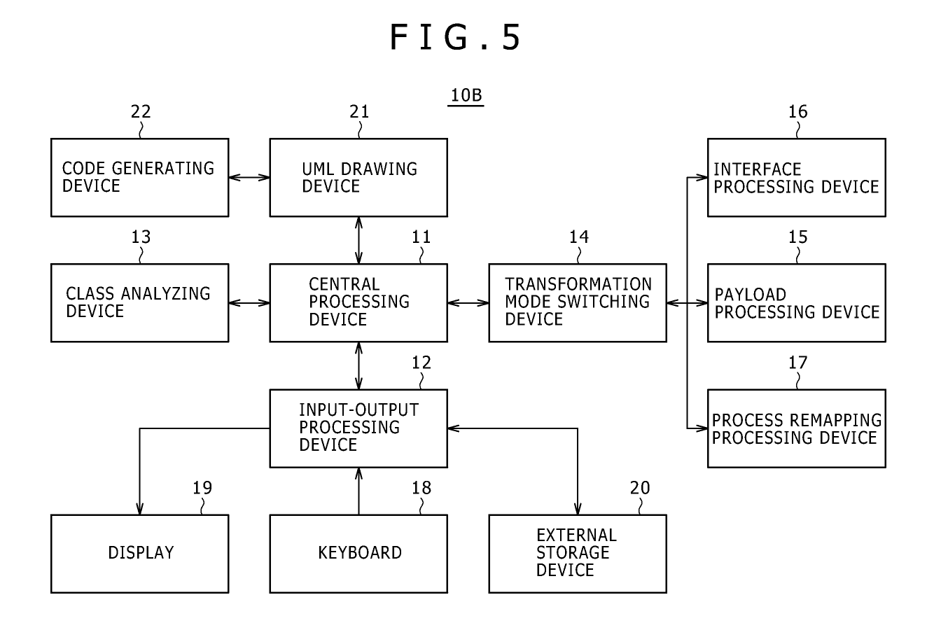

FIG. 5 is a diagram showing an example of configuration of a model transforming device according to a present third embodiment.

The model transforming device 10B of FIG. 5 is different from the model transforming device 10A of FIG. 4 in that a central processing device 11 in the model transforming device 10B communicates directly with a transformation mode switching device 14 without the intervention of a UML drawing device 21.

The other configuration is similar to that of the model transforming device 10A of FIG. 4.

### 4. Fourth Embodiment

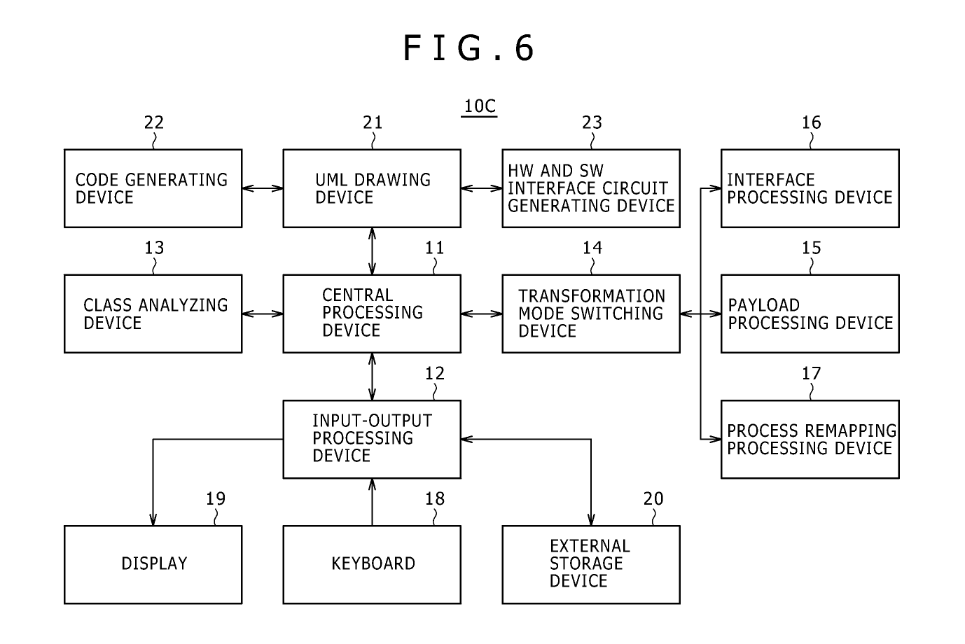

FIG. 6 is a diagram showing an example of configuration of a model transforming device according to a present fourth embodiment.

The model transforming device 10C of FIG. 6 is different from the model transforming device 10B of FIG. 5 in that an HW (hardware) and SW (software) interface circuit generating device 23 is connected to a UML drawing device 21.

The other configuration is similar to that of the model transforming device 10B of FIG. 5.

An HW and SW interface circuit is a device such as an address decoder, an interrupt controller, a chip enabler, or the like.

Incidentally, the processing of the HW and SW interface circuit generating device 23 can be performed by a program.

An example of configuration of functional blocks of the model transforming device 10 according to the present embodiment and functions of the functional blocks have been described above.

The model transformation processing according to the present embodiment will next be described more concretely in association with UML component diagrams, class diagrams, and the like.

### 5. More Concrete Processing Example of Model Transformation Processing

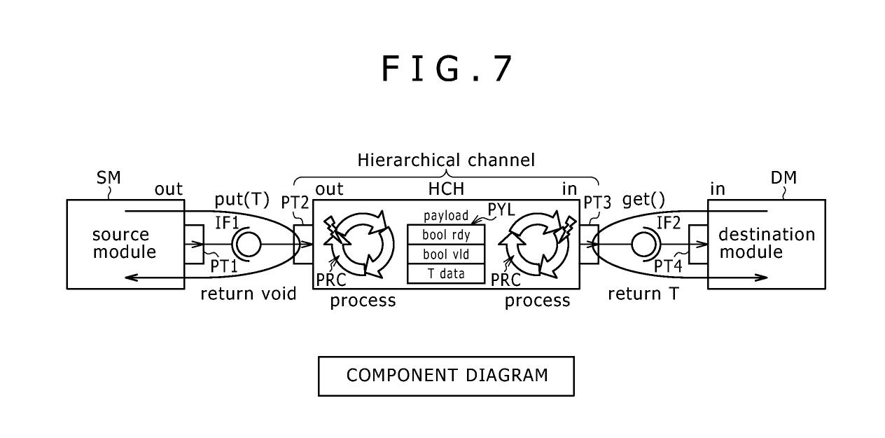

FIG. 7 is a UML component diagram of an interface model system described in SystemC.

In this UML component, a hierarchical channel HCH is disposed between a source module SM and a destination module DM.

The port PT1 of the source module SM and the port PT2 of the hierarchical channel HCH are configured so as to be able to give and receive information via an interface IF1.

The port PT3 of the hierarchical channel HCH and the port PT4 of the destination module DM are configured so as to be able to give and receive information via an interface IF2.

The interface IF1 includes a put function put(T). The interface IF2 includes a get function get( ). The put includes a transmitting function. The get includes a receiving function.

A payload PYL includes ready rdy, valid vld, and data dat.

The hierarchical channel HCH is thus used for interface description in SystemC.

As described above, the hierarchical channel HCH is a channel class capable of internally having processes PRC and is formed of a data class referred to as a payload PYL in which data itself as an object of transfer and a signal necessary for communication to transfer the data are integrated.

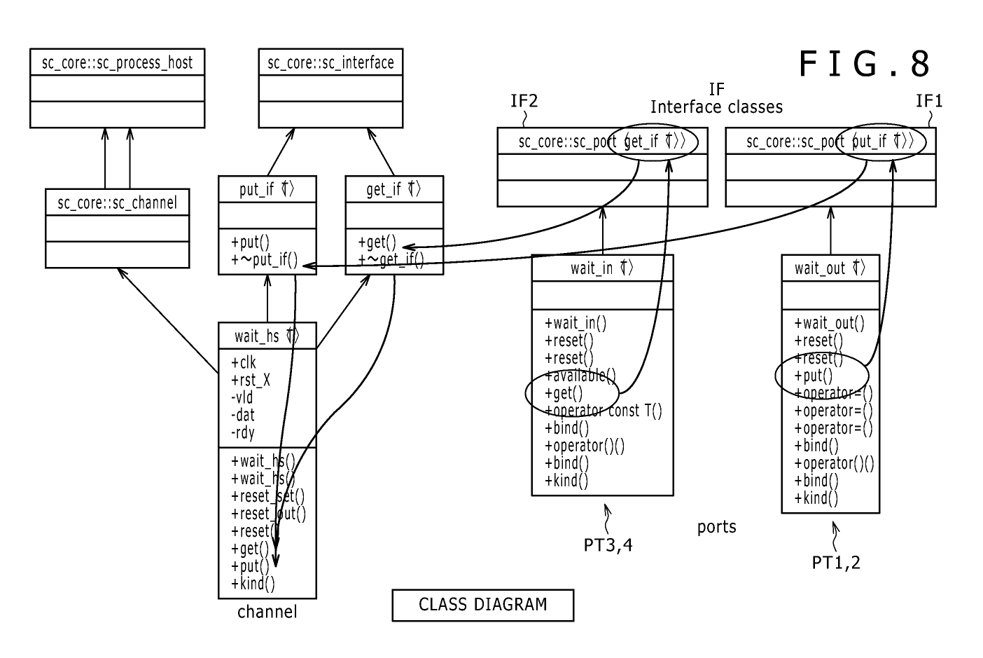

FIG. 8 is a class diagram of the hierarchical channel.

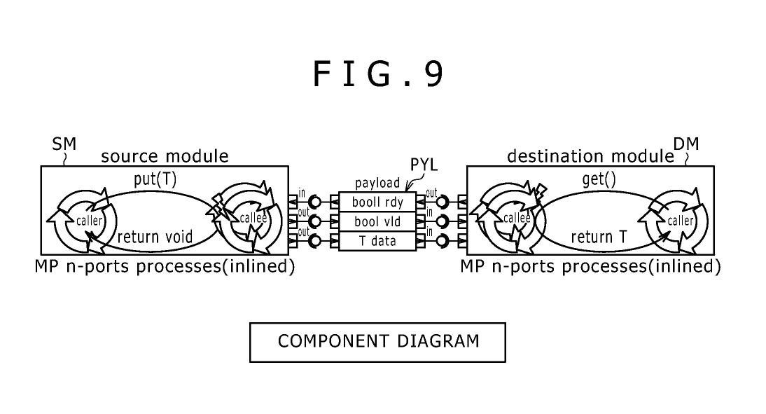

On the other hand, FIG. 9 is a UML component diagram of an interface model system capable of behavioral synthesis after model transformation.

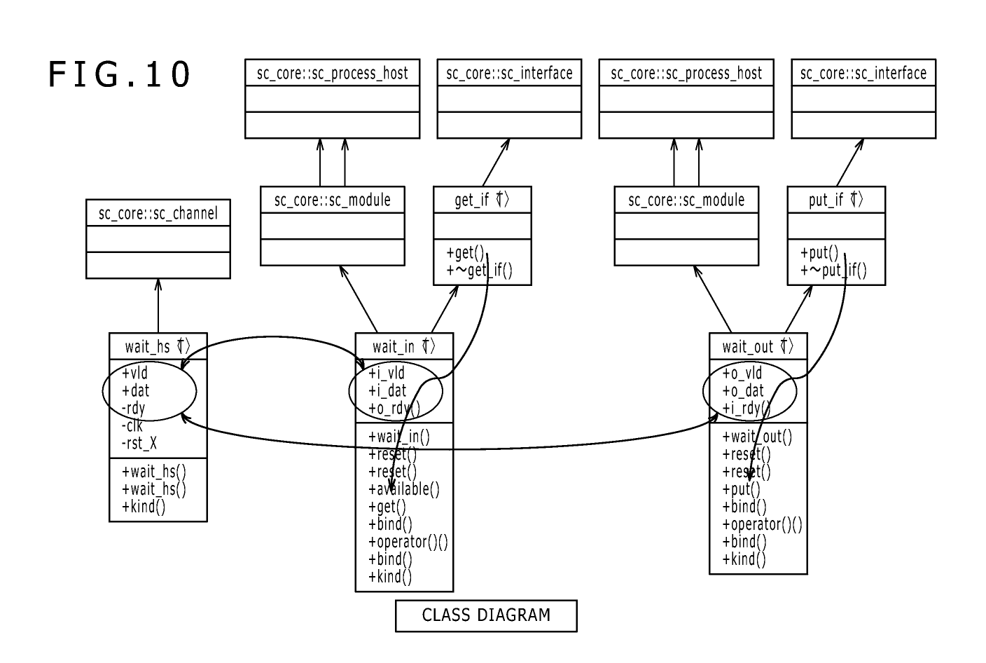

FIG. 10 is a class diagram of an interface part after the model transformation.

Proof that the model transforming device 10 according to the present embodiment can perform mutual transformation will be given in the following with reference to FIGS. 7 to 10.

[Proof that Mutual Transformation is Possible]

Algebraic definitions are introduced to class equivalence, conditional equivalence, and derivation for the proof that mutual transformation is possible.

### [Class Definitions]

Class definitions are basically as follows.

### [Equivalence]

Notation: class A=class B
Meaning: A class A and a class B are equivalent to each other, and interchangeable.

### [Conditional Equivalence]

Notation: $COND{M}class A=$COND(N)class B
Meaning: A class A when M is true and a class B when N is true are equivalent to each other, and interchangeable.

### [Derived Class]

Notation: class B: class A
Meaning: A class B is a derived class of a class A.

### [Member Function]

Notation: class A::Func
Meaning: A member function Func of a class A.
Algebraic definitions are introduced also from premises of SystemC.
[Definitions from Premises of SystemC]
sc_channel=sc_module
Meaning: An sc_channel is equivalent to an sc_module.
∀IF: sc_interface
Meaning: All interface classes are a derived class of an sc_interface class.
∀Port: sc_port<IF>
Meaning: All port classes are a derived class of an sc_port class with an interface class as a template parameter.
∀CH: sc_channel, Port
Meaning: All channel classes are a derived class of an sc_channel and a port class.

### Port $BIND CH

Meaning: A Port port class binds a CH channel class.

### $COND{M}

Meaning: A condition of M.
Port $BIND CĤ∃₁Func [symbol] =$COND{Port: IF}Port::Func=$COND{Port: sc_port<IF>̂ CH: IF}CH::Func
Meaning: When a certain port class binds a certain channel class, and there is a certain unique function, the following meaning is given.

The member function Func of the port class when the certain port is a derived class of a certain port interface and the member function Func of the channel class when the port class is a derived class of an sc_port with the certain interface class as a template parameter and the certain channel is a derived class of the certain interface class are equivalent to each other.

### Example

$COND{Port: put_if}Port::put( )=$COND{Port: sc_port<put_if>̂CH: put_if}CH::put( )}
$COND{Port: get_if}Port::get( )=$COND{Port: sc_port<get_if>̂CH: get_if}CH::get( )}

### $COND{Port $BIND CH}=$COND{∀{Port::PrimitivePort ∈ Port $BIND CH::PrimitiveCH ∈ CH}}

Meaning: A condition for a certain port class to bind a certain channel class is equivalent to a condition for all primitive ports belonging to the port class to bind all primitive channels belonging to the channel.

### [Formulation]

The following five equations (1) to (5) are obtained when the connection of the hierarchical channel is formulated from FIG. 7 and FIG. 8.

(1) wait_hs : sc_channel, put_if, get_if
Meaning: A wait_hs class is a derived class of an sc_channel, a put_if, and a get_if class.
(2) wait_out : sc_port<put_if>
Meaning: A wait_out class is a derived class of an sc_port with the put_if class as a template parameter.
(3) wait_in : sc_port<get_if>
Meaning: A wait_in class is a derived class of the sc_port with the get_if class as a template parameter.
(4) wait_out $BIND wait_hs
Meaning: The wait out_class binds the wait_hs class.
(5) wait_in $BIND wait_hs
Meaning: The wait_in class binds the wait_hs class.

The following nine equations <1> to <9> are obtained when the connection after model transformation is formulated from FIG. 8 and FIG. 10.

<1> wait_hs : sc_channel
Meaning: The wait_hs is a derived class of the sc_channel.
<2> wait_out : sc_module, put_if
Meaning: The wait_out class is a derived class of an sc_module and the put_if class.
<3> wait_in : sc_module, get_if
Meaning: The wait_in class is a derived class of the sc_module and the get_if class.
<4> wait_out::vld $BIND wait_hs::vld
Meaning: wait_out::vld binds wait_hs::vld.
<5> wait_out::rdy $BIND wait_hs::rdy
Meaning: wait_out::rdy binds wait hs::rdy.
<6> wait_out::dat $BIND wait_hs::dat
Meaning: wait_out::dat binds wait_hs::dat.
<7> wait_in::vld $BIND wait_hs::vld
Meaning: wait_in::vld binds wait_hs::vld.
<8> wait_in::rdy $BIND wait_hs::rdy
Meaning: wait_in::rdy binds wait_hs::rdy.
<9> wait_in::dat $BIND wait_hs::dat
Meaning: wait_in::dat binds wait_hs::dat.
[Proof that the Class Diagram of FIG. 8 Showing the Hierarchical Channel and the Interface Class Diagram of FIG. 10 After Model Transformation are Equivalent to Each Other]

Proof that the class diagram of FIG. 8 showing the hierarchical channel and the interface class diagram of FIG. 10 after model transformation are equivalent to each other is as follows.

### [Bind Condition]

The following relations are obtained from connection expressions after model transformation.

wait_out::vld $BIND wait_hs::vld
wait_out::rdy $BIND wait_hs::rdy
wait_out::dat $BIND wait_hs::dat
wait_in::vld $BIND wait_hs::vld
wait_in::rdy $BIND wait_hs::rdy
wait_in::dat $BIND wait_hs::dat

The following relations are obtained from the definition $COND{Port $BIND CH}=$COND{∀{Port::PrimitivePort ∈ Port $BIND CH::PrimitiveCH ∈ CH}}.

wait_out $BIND wait_hs
wait_in $BIND wait_hs

This is equal to the bind condition of the hierarchical channel connection.

Hence, both bind conditions are equivalent to each other.

The following relations are obtained from class algebra after the model transformation.

wait_hs : sc_channel
wait_out : sc_module, put_if
wait_in : sc_module, get_if

The following relations are obtained because the bind conditions are equivalent to each other and put( ) and get( )are each unique.

When PORT=wait_out, FUNC=put( ), IF=put_if, and CH=wait_hs are applied to the definition PORT $BIND CĤ [symbol] FUNC [symbol] $COND{PORT: IF}PORT::FUNC=$COND{PORT: sc_port<IF>̂CH: IF}CH::FUNC,
wait_out $BIND wait_hŝ [symbol] ₁put( ) [symbol] $COND{wait_out: put_if}wait_out::put( )=$COND{wait_out: sc_port<put_if>̂wait_hs: put_if}wait_hs::put( )

That is, the following relations are obtained.

wait_out: sc_port<put_if>
wait_hs: put_if}

The following relations are similarly obtained.

wait_in: sc_port<get_if>
wait_hs: get_if}

The relations are summarized as follows:

wait_out: sc_port<put_if>
wait_in: sc_port<get_if>
wait_hs: get_if}, put_if}
This is equivalent to the class algebra of the hierarchical channel.

### 6. First Example

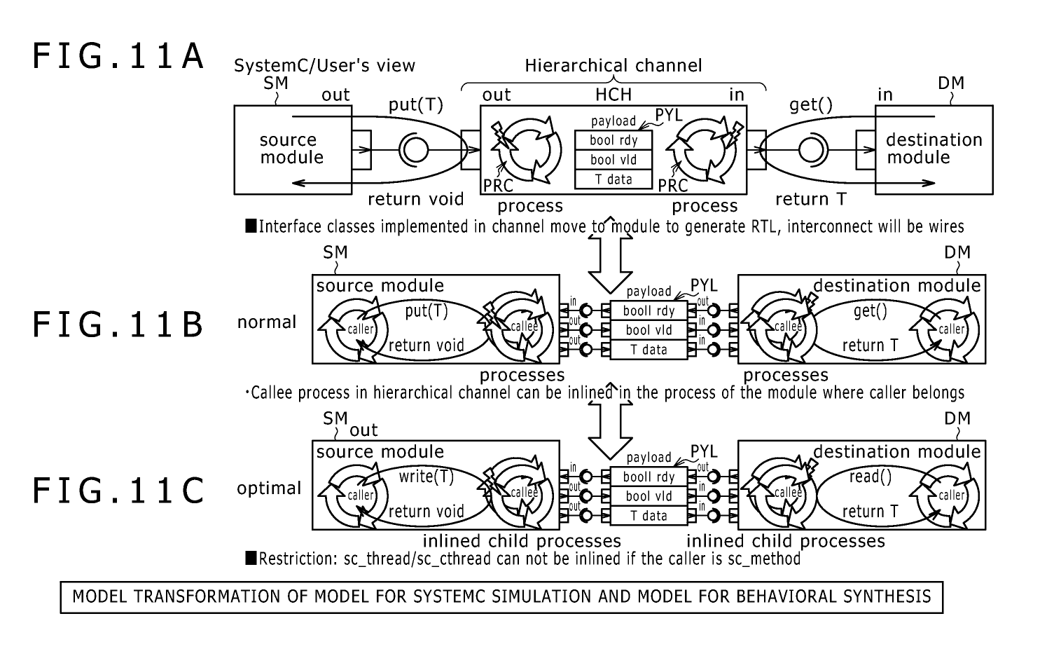

FIGS. 11A to 11C are diagrams of assistance in explaining a first example.

FIG. 11A is a UML component diagram in which a hierarchical channel connection is an input system.

When a SystemC description of a system is input to a present device, the system is modified into a model as shown in FIG. 11B as a derived class of a class according to the processing flow of FIGS. 2A to 2C and FIGS. 3A to 3C.

When inlining of processes within modules is advanced, the model is converted into a model as shown in FIG. 11C. However, inlining is not possible when a call is made from an sc_method.

The first example analyzes a C++ language, and outputs a new C++ language class after model transformation using interface and API decomposition (channel decomposition) or integration (channel integration) and process remapping technology that rearranges inherited relations and the positions of member functions.

### 7. Second Example

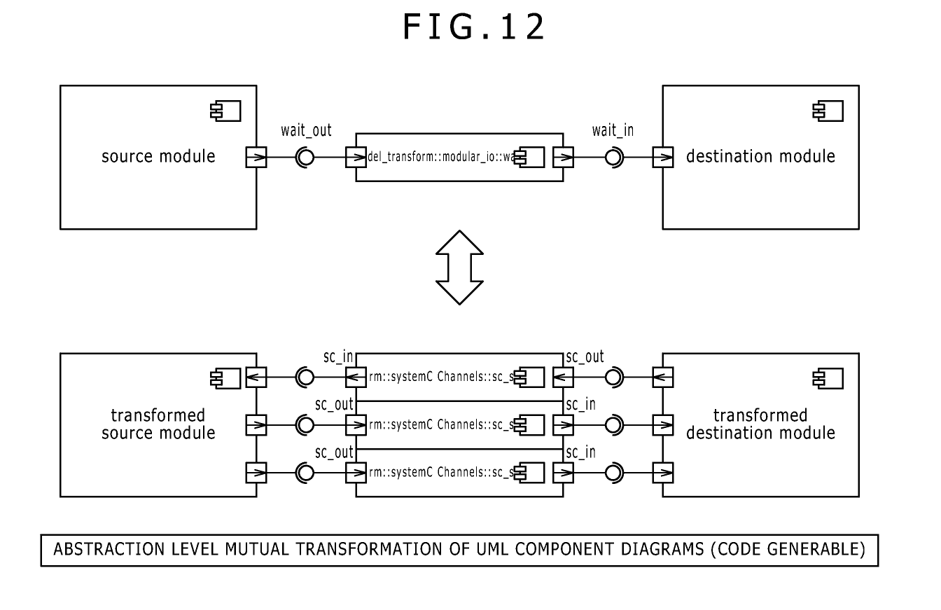

FIG. 12 is a diagram of assistance in explaining a second example.

A present model transforming device can abstract an object of analysis, when implemented as a system structure transforming device.

That is, the implementation is performed by directly rewriting the UML component diagrams of FIGS. 11A to 11C.

The present second example can construct a model much more quickly than the above-described first example.

A concrete operation procedure is as follows.

### [Channel Decomposition Procedure]

A channel decomposition procedure is as follows. The channel decomposition procedure is performed using a mouse or the like on a display.

A hierarchical channel is selected.

A drop-down menu is opened by a right click.

Decomposition is selected.

With this operation, a UML drawing tool decomposes a channel into a group of parameters within the channel, and generates ports in a source module and a destination module, respectively.

### [Channel Integration Procedure]

A group of channels to be integrated are selected.

A drop-down menu is opened by a right click.

Integration is selected.

With this operation, a UML drawing tool generates a hierarchical channel. The hierarchical channel contains integrated ports and integrated internal parameters.

Partial decomposition and integration may also be used.

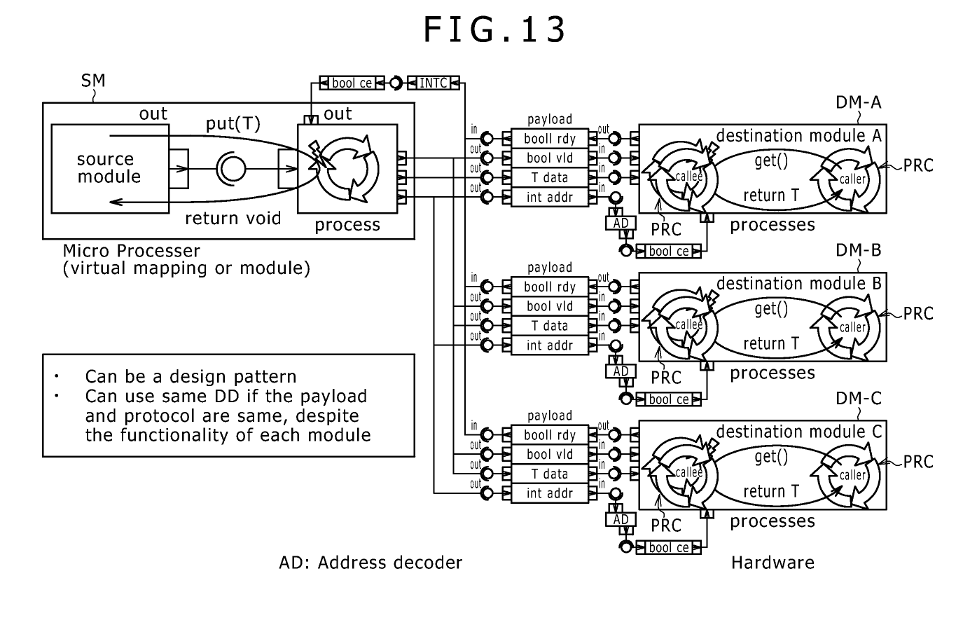

FIG. 13 is a diagram showing a case of design in which channel decomposition is performed on only a hardware side.

### [Channel Port (Partial) Decomposition Procedure]

A channel port (partial) decomposition procedure is as follows.

A port of a hierarchical channel is selected.

A drop-down menu is opened by a right click.

Decomposition is selected.

With this operation, a UML drawing tool decomposes only the selected port of the channel into a group of parameters within the channel. New ports are generated between a connected module and the channel.

### [Channel Port Integration Procedure]

A channel port integration procedure is as follows.

A group of ports of a module desired to be connected to a hierarchical channel are selected.

A drop-down menu is opened by a right click.

Integration is selected.

With this operation, a UML drawing tool generates the hierarchical channel. The hierarchical channel contains an integrated port and integrated parameters. However, a port side not selected is not integrated.

### 8. Third Example

Class simplification will be described as a third example.

### [Class Simplification]

In the third example, a redundant description part not executed may occur when class reuse and upgrading is repeated. Class transformation is used to organize this part.

### 9. Fourth Example

Class reconstruction will be described as a fourth example.

### [Class Reconstruction]

In the fourth example, a result of implementation in a derived class of a class can be moved to a base class and organized, or conversely a result of implementation in a base class can be moved to a derived class and the duty of the base class can be organized.

### 10. Fifth Example

Class equivalence verification will be described as a fifth example.

### [Class Equivalence Verification]

There is a structural transformation pattern for an equivalent class. The meaning of this structural transformation pattern is not understood well even when a program language is viewed, but the physical meaning of the structural transformation pattern can be understood when viewed in a UML diagram.

For example, for pure virtual functions, overrides, and derived classes in C++, there are physical meanings in conjunction with linguistic meanings as follows:

“Instantiation is always necessary in derived classes,” “the method of a base class is invalid and the method of a derived class is performed,” and “the method of a base class may be accessed.”

When an equivalent structural transformation pattern is prepared by showing each transformation in a diagram, and only the equivalent structural transformation pattern is used for transformation, the equivalence of a class after transformation can be ensured.

### [Example of Rules Used for Equivalent Transformation]

An example of rules used for equivalent transformation will next be shown.

a kind of method disclosed to the outside
a public method
a friend function: disclosure for each function
a friend class: disclosure for each class
access to a protected member within a base class from a derived class by inheritance
access to a member within a derived class from a base class by a virtual method

The above rules are all formulated, and theorems are organized.

As described above, according to the present embodiment, it is possible to mutually transform an interface model described in SystemC or UML and an interface model capable of behavioral synthesis while maintaining equivalence, and develop hardware effectively.

Incidentally, the present technology can adopt the following constitutions.

(1) A model transforming device including:

a processing section configured to modify respective algebra expressions of an interface model for simulation in a fixed description style and an interface model for behavioral synthesis in a fixed description style, and when both of the algebra expressions after being modified match each other, determine that the models have (mathematical) equivalence, and perform mutual transformation of the models;

wherein a hierarchical channel is used for interface description, the hierarchical channel being a channel class capable of internally having processes and being formed of a data class referred to as a payload in which data itself as an object of transfer and a signal necessary for communication to transfer the data are integrated, and

the processing section performs mutual equivalent transformation of hierarchical channel and integration channel model transformation by following three operations a, b, and c maintaining algebraic equivalence:

a: mutual equivalent transformation by payload disclosure and payload concealment operation,

b: interface and channel decomposition and interface and channel integration, and

c: process remapping operation.

(2) The model transforming device according to the above (1),

wherein in a transformation mode for transforming the interface model for simulation into the interface model for behavioral synthesis, the processing section performs payload disclosure undoing a bundle of a channel, interface and channel decomposition, and process remapping.

(3) The model transforming device according to the above (1) or (2),

wherein in a transformation mode for transforming the interface model for behavioral synthesis into the interface model for simulation, the processing section performs payload concealment binding channels, interface and channel integration, and process remapping.

(4) The model transforming device according to any one of the above (1) to (3),

wherein following four algebraic definitions of semantics e, f, g, and h are given as the algebra definitions:

e: class equivalence meaning that classes are interchangeable,

f: conditional class equivalence meaning that classes are interchangeable conditionally,

g: derived class meaning that a class is derived from a certain class, and

h: member function meaning that a certain function belongs to a certain class.

(5) The model transforming device according to any one of the above (1) to (3),

wherein when a SystemC language is a design description language, following seven algebraic definitions of semantics i, j, k, l, m, n, and o are given as the algebra definitions:

i: an sc_channel and an sc_module are class-equivalent to each other,

j: all interface classes are a derived class of an sc_interface class,

k: all port classes are a derived class of an sc_port class with an interface class as a template parameter,

l: a port class binds a channel class,

m: a condition of M,

n: when a certain port class binds a certain channel class, and there is a certain unique function,
n1: the member function of the port class when the certain port class is a derived class of a certain interface class and
n2: the member function of the channel class when the port class is a derived class of an sc_port with the certain interface class as a template parameter and the certain channel is a derived class of the certain interface class are equivalent to each other, and

o: a condition for a certain port class to bind a certain channel class is equivalent to a condition for all primitive ports belonging to the port class to bind all primitive channels belonging to the channel.

(6) A model transforming method including:

modifying respective algebra expressions of an interface model for simulation in a fixed description style and an interface model for behavioral synthesis in a fixed description style;

determining whether both of the algebra expressions after being modified match each other; and

when both of the algebra expressions after being modified match each other, determining that the models have (mathematical) equivalence, and performing mutual transformation of the models;

wherein a hierarchical channel is used for interface description, the hierarchical channel being a channel class capable of internally having processes and being formed of a data class referred to as a payload in which data itself as an object of transfer and a signal necessary for communication to transfer the data are integrated, and

mutual equivalent transformation of hierarchical channel and integration channel model transformation is performed by following three operations a, b, and c maintaining algebraic equivalence:

a: mutual equivalent transformation by payload disclosure and payload concealment operation,

b: interface and channel decomposition and interface and channel integration, and

c: process remapping operation.

(7) The model transforming method according to the above (6),

wherein in a transformation mode for transforming the interface model for simulation into the interface model for behavioral synthesis, payload disclosure undoing a bundle of a channel, interface and channel decomposition, and process remapping are performed.

(8) The model transforming method according to the above (6) or (7),

wherein in a transformation mode for transforming the interface model for behavioral synthesis into the interface model for simulation, payload concealment binding channels, interface and channel integration, and process remapping are performed.

(9) The model transforming method according to any one of the above (6) to (8),

wherein following four algebraic definitions of semantics e, f, g, and h are given as the algebra definitions:

e: class equivalence meaning that classes are interchangeable,

f: conditional class equivalence meaning that classes are interchangeable conditionally,

g: derived class meaning that a class is derived from a certain class, and

h: member function meaning that a certain function belongs to a certain class.

(10) The model transforming method according to any one of the above (6) to (8),

wherein when a SystemC language is a design description language, following seven algebraic definitions of semantics i, j, k, l, m, n, and o are given as the algebra definitions:

i: an sc_channel and an sc_module are class-equivalent to each other,

j: all interface classes are a derived class of an sc_interface class,

k: all port classes are a derived class of an sc_port class with an interface class as a template parameter,

l: a port class binds a channel class,

m: a condition of M,
n: when a certain port class binds a certain channel class, and there is a certain unique function,
n1: the member function of the port class when the certain port class is a derived class of a certain interface class and
n2: the member function of the channel class when the port class is a derived class of an sc_port with the certain interface class as a template parameter and the certain channel is a derived class of the certain interface class are equivalent to each other, and

o: a condition for a certain port class to bind a certain channel class is equivalent to a condition for all primitive ports belonging to the port class to bind all primitive channels belonging to the channel.

(11) A program for making a computer perform model transformation processing, including:

modifying respective algebra expressions of an interface model for simulation in a fixed description style and an interface model for behavioral synthesis in a fixed description style;

determining whether both of the algebra expressions after being modified match each other; and

when both of the algebra expressions after being modified match each other, determining that the models have (mathematical) equivalence, and performing mutual transformation of the models;

wherein a hierarchical channel is used for interface description, the hierarchical channel being a channel class capable of internally having processes and being formed of a data class referred to as a payload in which data itself as an object of transfer and a signal necessary for communication to transfer the data are integrated, and

mutual equivalent transformation of hierarchical channel and integration channel model transformation is performed by following three operations a, b, and c maintaining algebraic equivalence:

a: mutual equivalent transformation by payload disclosure and payload concealment operation,

b: interface and channel decomposition and interface and channel integration, and

c: process remapping operation.

The present disclosure contains subject matter related to that disclosed in Japanese Priority Patent Application JP 2011-183827 filed in the Japan Patent Office on Aug. 25, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A model transforming device, comprising:
a processing section configured to modify respective algebra expressions of an interface model for simulation in a fixed description style and an interface model for behavioral synthesis in a fixed description style, and when both of the algebra expressions after being modified match each other, determine that the models have equivalence, and perform mutual transformation of the models;
wherein a hierarchical channel is used for interface description, the hierarchical channel being a channel class capable of internally having processes and being formed of a data class referred to as a payload in which data itself as an object of transfer and a signal necessary for communication to transfer the data are integrated, and
the processing section performs mutual equivalent transformation of hierarchical channel and integration channel model transformation by following three operations a, b, and c maintaining algebraic equivalence:
a: mutual equivalent transformation by payload disclosure and payload concealment operation,
b: interface and channel decomposition and interface and channel integration, and
c: process remapping operation.

2. The model transforming device according to claim 1,
wherein in a transformation mode for transforming the interface model for simulation into the interface model for behavioral synthesis, the processing section performs payload disclosure undoing a bundle of a channel, interface and channel decomposition, and process remapping.

3. The model transforming device according to claim 1,
wherein in a transformation mode for transforming the interface model for behavioral synthesis into the interface model for simulation, the processing section performs payload concealment binding channels, interface and channel integration, and process remapping.

4. The model transforming device according to claim 1,
wherein following four algebraic definitions of semantics e, f, g, and h are given as the algebra definitions:
e: class equivalence meaning that classes are interchangeable,
f: conditional class equivalence meaning that classes are interchangeable conditionally,
g: derived class meaning that a class is derived from a certain class, and
h: member function meaning that a certain function belongs to a certain class.

5. The model transforming device according to claim 1,
wherein when a SystemC language is a design description language, following seven algebraic definitions of semantics i, j, k, l, m, n, and o are given as the algebra definitions:
i: an sc_channel and an sc_module are class-equivalent to each other,
j: all interface classes are a derived class of an sc_interface class,
k: all port classes are a derived class of an sc_port class with an interface class as a template parameter,
l: a port class binds a channel class,
m: a condition of M,
n: when a certain port class binds a certain channel class, and there is a certain unique function,
n1: the member function of the port class when the certain port class is a derived class of a certain interface class and
n2: the member function of the channel class when the port class is a derived class of an sc_port with the certain interface class as a template parameter and the certain channel is a derived class of the certain interface class are equivalent to each other, and
o: a condition for a certain port class to bind a certain channel class is equivalent to a condition for all primitive ports belonging to the port class to bind all primitive channels belonging to the channel.

6. A model transforming method, comprising:
modifying respective algebra expressions of an interface model for simulation in a fixed description style and an interface model for behavioral synthesis in a fixed description style;
determining whether both of the algebra expressions after being modified match each other; and
when both of the algebra expressions after being modified match each other, determining that the models have equivalence, and performing mutual transformation of the models;
wherein a hierarchical channel is used for interface description, the hierarchical channel being a channel class capable of internally having processes and being formed of a data class referred to as a payload in which data itself as an object of transfer and a signal necessary for communication to transfer the data are integrated, and
mutual equivalent transformation of hierarchical channel and integration channel model transformation is performed by following three operations a, b, and c maintaining algebraic equivalence:
a: mutual equivalent transformation by payload disclosure and payload concealment operation,
b: interface and channel decomposition and interface and channel integration, and
c: process remapping operation.

7. The model transforming method according to claim 6,
wherein in a transformation mode for transforming the interface model for simulation into the interface model for behavioral synthesis, payload disclosure undoing a bundle of a channel, interface and channel decomposition, and process remapping are performed.

8. The model transforming method according to claim 6,
wherein in a transformation mode for transforming the interface model for behavioral synthesis into the interface model for simulation, payload concealment binding channels, interface and channel integration, and process remapping are performed.

9. The model transforming method according to claim 6,
wherein following four algebraic definitions of semantics e, f, g, and h are given as the algebra definitions:
e: class equivalence meaning that classes are interchangeable,
f: conditional class equivalence meaning that classes are interchangeable conditionally,
g: derived class meaning that a class is derived from a certain class, and
h: member function meaning that a certain function belongs to a certain class.

10. The model transforming method according to claim 6,
wherein when a SystemC language is a design description language, following seven algebraic definitions of semantics i, j, k, l, m, n, and o are given as the algebra definitions:
i: an sc_channel and an sc_module are class-equivalent to each other,
j: all interface classes are a derived class of an sc_interface class,
k: all port classes are a derived class of an sc_port class with an interface class as a template parameter,
l: a port class binds a channel class,
m: a condition of M,
n: when a certain port class binds a certain channel class, and there is a certain unique function,
n1: the member function of the port class when the certain port class is a derived class of a certain interface class and
n2: the member function of the channel class when the port class is a derived class of an sc_port with the certain interface class as a template parameter and the certain channel is a derived class of the certain interface class are equivalent to each other, and
o: a condition for a certain port class to bind a certain channel class is equivalent to a condition for all primitive ports belonging to the port class to bind all primitive channels belonging to the channel.

11. A program for making a computer perform model transformation processing, comprising:
modifying respective algebra expressions of an interface model for simulation in a fixed description style and an interface model for behavioral synthesis in a fixed description style;
determining whether both of the algebra expressions after being modified match each other; and
when both of the algebra expressions after being modified match each other, determining that the models have (mathematical) equivalence, and performing mutual transformation of the models;
wherein a hierarchical channel is used for interface description, the hierarchical channel being a channel class capable of internally having processes and being formed of a data class referred to as a payload in which data itself as an object of transfer and a signal necessary for communication to transfer the data are integrated, and
mutual equivalent transformation of hierarchical channel and integration channel model transformation is performed by following three operations a, b, and c maintaining algebraic equivalence:
a: mutual equivalent transformation by payload disclosure and payload concealment operation,
b: interface and channel decomposition and interface and channel integration, and
c: process remapping operation.
